(19) United States
(12) Patent Application Publication
(10) Pub. No.: US 2023/0089391 A1
(43) Pub. Date: Mar. 23, 2023

(54) POSITIVE ELECTRODE PLATE AND BATTERY

(71) Applicant: ZHUHAI COSMX BATTERY CO., LTD., Zhuhai (CN)

(72) Inventors: Weichao TANG, Zhuhai (CN); Suli LI, Zhuhai (CN); Wei ZHAO, Zhuhai (CN); Ruofan CHEN, Zhuhai (CN); Chunyang LIU, Zhuhai (CN); Junyi LI, Zhuhai (CN); Yanming XU, Zhuhai (CN)

(73) Assignee: ZHUHAI COSMX BATTERY CO., LTD., Zhuhai (CN)

(21) Appl. No.: 18/070,172

(22) Filed: Nov. 28, 2022

Related U.S. Application Data
(63) Continuation-in-part of application No. PCT/CN2021/094176, filed on May 17, 2021.
Application No. PCT/CN2021/094176 is a continuation-in-part of application No. PCT/CN2021/094177, filed on May 17, 2021.

(30) Foreign Application Priority Data
May 29, 2020 (CN) 202010479690.9
May 29, 2020 (CN) 202010479706.6

(51) Int. Cl. H01M 4/36; H01M 4/139; H01M 4/66; H01M 4/62; H01M 4/04

(52) U.S. Cl. CPC H01M 4/366; H01M 4/139; H01M 4/667; H01M 4/668; H01M 4/621; H01M 4/624; H01M 4/0404; H01M 2004/028

(57) ABSTRACT

Disclosed are a positive electrode plate and a battery including the positive electrode plate. The positive electrode plate includes a positive electrode current collector, at least one thermosensitive coating layer, at least one composite fusion layer, and at least one positive electrode active material layer. The thermosensitive coating layer has electrical conductivity at room temperature, and has advantages of increasing a contact area between the active material and the current collector, effectively reducing battery polarization, and the like. When a temperature of the positive electrode plate during use reaches a thermosensitive temperature and higher, thermosensitive polymer microspheres melt to form at least one continuous electron blocking layer, therefore forming a current blockage, and an internal blockage is formed inside the battery, thereby preventing further thermal runaway of a secondary battery, and improving safety performance of the secondary battery.

### CROSS-REFERENCE TO RELATED APPLICATIONS

The present disclosure is a continuation-in-part of International Application No. PCT/CN2021/094176, filed on May 17, 2021, which claims priority to Chinese Patent Application No. CN202010479690.9, filed on May 29, 2020. The present disclosure is also a continuation-in-part of International Application No. PCT/CN2021/094177, filed on May 17, 2021, which claims priority to Chinese Patent Application No. CN202010479706.6, filed on May 29, 2020. The entire contents of the aforementioned applications are incorporated herein by reference.

### TECHNICAL FIELD

The present disclosure relates to the field of batteries, and in particular, to a positive electrode plate and a battery including the positive electrode plate.

### BACKGROUND

Batteries have been widely used in various fields, and in recent years, the market has imposed increasingly high requirements for the performance of batteries. With the continuous improvement of battery performance, safety issues caused by thermal runaway of batteries have also attracted more and more attention.

In order to improve the safety of a battery, various solutions have been proposed, including providing a positive temperature coefficient (PTC) coating layer inside the battery. However, the current PTC coating layer has problems such as high internal resistance of the battery, reduced cycling performance, and poor PTC effect during actual applications, and thus needs to be further improved.

### SUMMARY

To overcome the disadvantages of the prior art, the objective of the present disclosure is to provide a positive electrode plate and a battery including the positive electrode plate. The positive electrode plate of the present disclosure includes a thermosensitive coating layer. The thermosensitive coating layer has electrical conductivity and provides a high-temperature blockage, and has little impact on an internal resistance of the battery. The positive electrode plate does not have any adverse effects in a normal use environment. When a thermosensitive temperature is reached, thermosensitive polymer microspheres in the thermosensitive coating layer melt to form a plurality of continuous electron blocking layers, such that the coating layer forms a current blockage, and an internal blockage is formed inside the battery, thereby preventing further thermal runaway of the battery, and fundamentally solving the safety problem of the battery. The positive electrode plate of the present disclosure has good compatibility with a solvent. The battery obtained has a low resistance, and the battery has good cycling performance. In addition, the battery has a good PTC effect during thermal runaway, and an excellent thermal blockage can be achieved.

In order to achieve the above objective, a first aspect of the present disclosure provides a positive electrode plate, including a positive electrode current collector, a thermosensitive coating layer, a composite fusion layer, and a positive electrode active material layer, wherein at least one set of the thermosensitive coating layer and the positive electrode active material layer is provided on a surface of the positive electrode current collector, and the composite fusion layer is provided between the thermosensitive coating layer and the positive electrode active material layer; the thermosensitive coating layer includes thermosensitive polymer microspheres, a first conductive agent, a first binder, an auxiliary agent, and an optional first positive electrode active material; the positive electrode active material layer includes a second positive electrode active material, a second conductive agent, and a second binder; and the composite fusion layer includes the thermosensitive polymer microspheres, the first conductive agent, the first binder, the auxiliary agent, the second positive electrode active material, the second conductive agent, the second binder, and the optional first positive electrode active material.

In an embodiment, one set of the thermosensitive coating layer and the positive electrode active material layer is provided on the surface of the positive electrode current collector, and the thermosensitive coating layer and the positive electrode active material layer are provided on the surface of the positive electrode current collector in one of the following sequences:

(1) the positive electrode current collector, the thermosensitive coating layer, and the positive electrode active material layer;

(2) the positive electrode current collector, the thermosensitive coating layer, the positive electrode active material layer, and the thermosensitive coating layer;

(3) the positive electrode current collector, the positive electrode active material layer, and the thermosensitive coating layer; and

(4) the positive electrode current collector, the positive electrode active material layer, the thermosensitive coating layer, and the positive electrode active material layer.

In an embodiment, N thermosensitive coating layers and M positive electrode active material layers are successively and alternately provided on the surface of the positive electrode current collector, and P composite fusion layers are provided, where N≥2, N+1≥M≥N−1, M≥2, and P=N+M−1.

In an embodiment, N=2, 3, or 4.

In an embodiment, the thermosensitive coating layer and the positive electrode active material layer are provided on the surface of the positive electrode current collector in one of the following sequences:

(1) the positive electrode current collector, the thermosensitive coating layer, the positive electrode active material layer, . . . , the thermosensitive coating layer, and the positive electrode active material layer;

(2) the positive electrode current collector, the thermosensitive coating layer, the positive electrode active material layer, . . . , the thermosensitive coating layer, the positive electrode active material layer, and the thermosensitive coating layer;

(3) the positive electrode current collector, the positive electrode active material layer, the thermosensitive coating layer, . . . , the positive electrode active material layer, the thermosensitive coating layer, and the positive electrode active material layer; and

(4) the positive electrode current collector, the positive electrode active material layer, the thermosensitive coating layer, . . . , the positive electrode active material layer, and the thermosensitive coating layer.

In an embodiment, each thermosensitive coating layer independently includes components of the following weight percentages: 1.1˜95 wt % of the thermosensitive polymer microspheres, 2.9˜48.9 wt % of the first conductive agent, 2˜40 wt % of the first binder, and 0.1˜10 wt % of the auxiliary agent; or 5˜90 wt % of the thermosensitive polymer microspheres, 5˜90 wt % of the first positive electrode active material, 2.9˜40 wt % of the first conductive agent, 2˜20 wt % of the first binder, and 0.1˜5 wt % of the auxiliary agent.

In an embodiment, the thermosensitive coating layer includes components of the following weight percentages: 65˜80 wt % of the thermosensitive polymer microspheres, 5˜15 wt % of the first positive electrode active material, 5˜15 wt % of the first conductive agent, 4.5˜15 wt % of the first binder, and 0.1˜4 wt % of the auxiliary agent.

In an embodiment, each positive electrode active material layer independently includes components of the following weight percentages: 80˜99 wt % of the second positive electrode active material, 0.5˜10 wt % of the second conductive agent, and 0.5˜10 wt % of the second binder.

In an embodiment, a thickness of the thermosensitive coating layer ranges from 0.1 μm to 5 μm.

In an embodiment, a thickness of the current collector ranges from 0.1 μm to 20 μm.

In an embodiment, a thickness of the composite fusion layer ranges from 0.001 μm to 0.5 μm.

In an embodiment, a thickness of the positive electrode active material layer ranges from 5 μm to 175 μm.

In an embodiment, a thickness of the positive electrode plate ranges from 50 μm to 200 μm.

In an embodiment, a particle size of the thermosensitive polymer microspheres ranges from 100 nm to 3.0 μm.

In an embodiment, a thermosensitive temperature of the thermosensitive polymer microspheres ranges from 115° C. to 160° C.

In an embodiment, the thermosensitive polymer microspheres are selected from at least one of polyethylene, polypropylene, polyamide, polyester amide, polystyrene, polyvinyl chloride, polyester, polyurethane, olefin copolymer, or a monomer-modified copolymerized polymer thereof.

In an embodiment, the thermosensitive polymer microspheres are selected from at least one of polyethylene, polypropylene, a propylene-ethylene-acrylate copolymer with a mole ratio between propylene and ethylene/acrylate being (10˜1):1, an ethylene-acrylate copolymer with a mole ratio between ethylene and propylene being (10˜1):1, an ethylene-acrylate copolymer with a mole ratio between ethylene and acrylate being (10˜1):1, and an ethylene-vinyl acetate copolymer with a mole ratio between ethylene and vinyl acetate being (10˜1):1.

In an embodiment, a resistance of the positive electrode plate is less than 10Ω.

A second aspect of the present disclosure provides a method for preparing the positive electrode plate according to the first aspect, the method including the following steps:

(1) performing first mixing on a first solvent, thermosensitive polymer microspheres, a first conductive agent, a first binder, an auxiliary agent, and an optional first positive electrode active material, to obtain thermosensitive coating layer slurry;

(2) performing second mixing on a second solvent, a second positive electrode active material, a second conductive agent, and a second binder, to obtain positive electrode active material layer slurry; and

(3) successively and alternately applying the thermosensitive coating layer slurry obtained in step (1) or the positive electrode active material layer slurry obtained in step (2) on a surface of a positive electrode current collector, and drying to obtain the positive electrode plate.

In an embodiment, the first mixing includes: first mixing the components other than the thermosensitive polymer microspheres, screening the mixed components through a sieve and then mixing the screened components with the thermosensitive polymer microspheres, and screening the mixed components and thermosensitive polymer microspheres through the sieve again to obtain the thermosensitive coating layer slurry.

A third aspect of the present disclosure provides a battery, the battery including a positive electrode plate according to the first aspect.

Optionally, the battery is a secondary battery and/or a lithium-ion battery.

In an embodiment, when a capacity retention of the battery decreases to 80% at 25° C. and a 1C/1C charge-discharge regime, a number of cycles is greater than or equal to 1100.

The thermosensitive coating layer in the positive electrode plate of the present disclosure has electrical conductivity at room temperature, and has the advantages of increasing a contact area between the active material and the current collector, effectively reducing battery polarization, and the like. When the thermosensitive coating layer includes a first positive electrode active material, high safety of the positive electrode plate is maintained, and overall active material content in the positive electrode plate is also increased, thereby increasing overall energy density of the battery. When a temperature of the positive electrode plate during use reaches a thermosensitive temperature and higher, thermosensitive polymer microspheres melt to form at least one continuous electron blocking layer, such that the coating layer forms a current blockage, and an internal blockage is formed inside the battery, thereby preventing further thermal runaway of the secondary battery, and improving the safety performance of the secondary battery. The positive electrode plate of the present disclosure has good compatibility with a solvent. The battery obtained has a low resistance, and the battery has good cycling performance. In addition, the battery has a good PTC effect during thermal runaway, and an excellent thermal blockage can be achieved.

Other features and advantages of the present disclosure are described in detail in the detailed description that follows.

### BRIEF DESCRIPTION OF THE DRAWINGS

FIG. 1 is a schematic diagram of a structure at room temperature of a positive electrode plate provided with one set of a thermosensitive coating layer and a positive electrode active material layer according to the present disclosure.

FIG. 2 is a schematic diagram of a structure at high temperature of a positive electrode plate provided with one set of a thermosensitive coating layer and a positive electrode active material layer according to the present disclosure.

FIG. 3 is a schematic diagram of a structure at room temperature of a positive electrode plate provided with a plurality of sets of a thermosensitive coating layer and a positive electrode active material layer according to the present disclosure.

FIG. 4 is a schematic diagram of a structure at high temperature of a positive electrode plate provided with a plurality of sets of a thermosensitive coating layer and a positive electrode active material layer according to the present disclosure.

FIG. 5 shows curves of changes of resistance values of positive electrode plates of Example 10 and Comparative Examples 1 and 2 as the temperature increases.

FIG. 6 shows ARC test results of batteries prepared according to Example 10 and Comparative Examples 1 and 2.

FIG. 7 is a schematic diagram of a resistance test for a positive electrode plate according to the present disclosure.

FIG. 8 shows a cross-sectional SEM of a coating layer region in a positive electrode plate prepared according to Example 13.

### DETAILED DESCRIPTIONS OF THE EMBODIMENTS

Specific implementations of the present disclosure are described below in detail. It should be understood that the specific implementations described herein are merely used for the purposes of illustrating and explaining the present disclosure, rather than limiting the present disclosure.

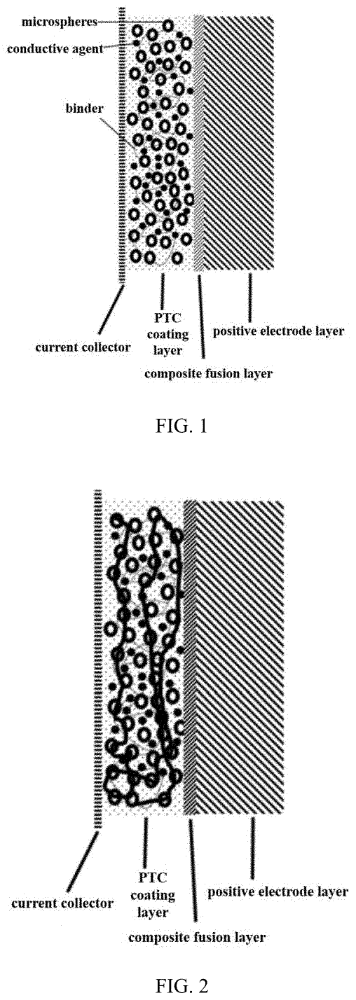

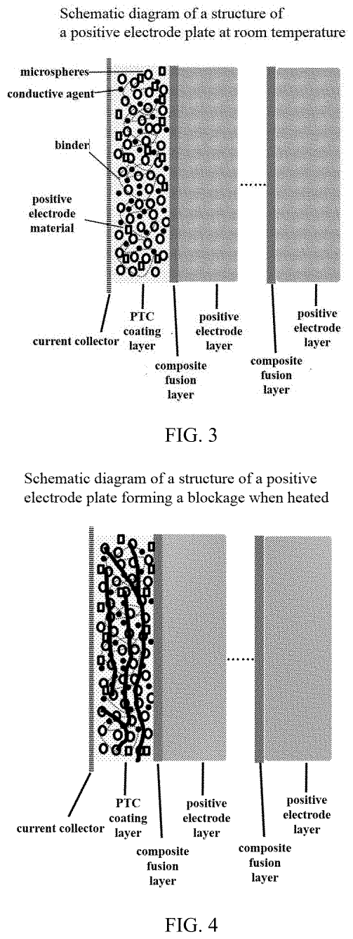

A first aspect of the present disclosure provides a positive electrode plate, as shown in FIG. 1 and FIG. 3. The positive electrode plate includes a positive electrode current collector, a thermosensitive coating layer, a composite fusion layer, and a positive electrode active material layer. At least one set of the thermosensitive coating layer and the positive electrode active material layer is provided on a surface of the positive electrode current collector, and the composite fusion layer is provided between the thermosensitive coating layer and the positive electrode active material layer.

The thermosensitive coating layer includes thermosensitive polymer microspheres, a first conductive agent, a first binder, an auxiliary agent, and an optional first positive electrode active material.

The positive electrode active material layer includes a second positive electrode active material, a second conductive agent, and a second binder.

The composite fusion layer includes the thermosensitive polymer microspheres, the first conductive agent, the first binder, the auxiliary agent, the second positive electrode active material, the second conductive agent, the second binder, and the optional first positive electrode active material.

The thermosensitive coating layer and the positive electrode active material layer are provided on the surface of the positive electrode current collector, and the thermosensitive coating layer and the positive electrode active material layer are fused with each other on the contact surface to form a composite fusion layer. For the convenience of description, a position of the composite fusion layer is not particularly specified herein, and it may be understood that the composite fusion layer is always present on the contact surface of the thermosensitive coating layer and the positive electrode active material layer.

In the present disclosure, the thermosensitive coating layer and the positive electrode active material layer are considered as a set, a sequence of their positions being not limited. In other words, the thermosensitive coating layer may be a lower layer (in contact with the positive electrode current collector) or an upper layer (away from the positive electrode current collector).

In addition, a number of sets is not limited to an integer, that is, a single thermosensitive coating layer or a single positive electrode active material layer may be provided at the outermost layer.

In an embodiment, only one set of the thermosensitive coating layer and the positive electrode active material layer may be provided on the surface of the positive electrode current collector, for example, as shown in FIG. 1.

When only one set is provided, the thermosensitive coating layer and the positive electrode active material layer are provided on the surface of the positive electrode current collector in one of the following sequences (the composite fusion layer is omitted; and the composite fusion layer is present on the contact surface of each thermosensitive coating layer and each positive electrode active material layer):

(1) the positive electrode current collector, the thermosensitive coating layer, and the positive electrode active material layer;

(2) the positive electrode current collector, the thermosensitive coating layer, the positive electrode active material layer, and the thermosensitive coating layer;

(3) the positive electrode current collector, the positive electrode active material layer, and the thermosensitive coating layer; and

(4) the positive electrode current collector, the positive electrode active material layer, the thermosensitive coating layer, and the positive electrode active material layer.

In another embodiment, two or more sets of the thermosensitive coating layer and the positive electrode active material layer may alternatively be provided on the surface of the positive electrode current collector, for example, as shown in FIG. 3.

When two or more sets are provided, N thermosensitive coating layers and M positive electrode active material layers are successively and alternately provided (without limiting the sequence) on the surface of the positive electrode current collector. A composite fusion layer is formed on a contact surface of each thermosensitive coating layer and each positive electrode active material layer, and there are P composite fusion layers in total.

N, M, and P are all positive integers, and optional ranges thereof are N≥1, N+1≥M≥N−1, M≥1, and P=N+M−1. The cases where N=1 and M=1 or 2 and where M=1 and N=1 or 2 are the above-mentioned cases where one set of the thermosensitive coating layer and the positive electrode active material layer is provided.

In an embodiment where two or more sets are provided, the following needs to be satisfied: N≥2, N+1≥M≥N−1, M≥2, and P=N+M−1.

In a preferred embodiment, 4≥N≥1 (i.e., N=1, 2, 3, or 4). For example, N=1, and M=1 or 2; or N=2, and M=1, 2, or 3; or N=3, and M=2, 3, or 4; or N=4, and M=3, 4, or 5.

The thermosensitive coating layer and the positive electrode active material layer are successively (one layer at a time) and alternately provided on the surface of the positive electrode current collector, and the sequence (that is, a material of the first layer in contact with the positive electrode current collector) may not be limited.

Exemplarily, the sequence may be one of the following sequences (the layer in brackets is optional; and the composite fusion layer is omitted):

(1) the positive electrode current collector, the thermosensitive coating layer, the positive electrode active material layer, (the thermosensitive coating layer, the positive electrode active material layer), . . . , the thermosensitive coating layer, and the positive electrode active material layer;

(2) the positive electrode current collector, the thermosensitive coating layer, the positive electrode active material layer, (the thermosensitive coating layer, the positive electrode active material layer), . . . , the thermosensitive coating layer, the positive electrode active material layer, and the thermosensitive coating layer;

(3) the positive electrode current collector, the positive electrode active material layer, the thermosensitive coating layer, (the positive electrode active material layer, the thermosensitive coating layer), . . . , the positive electrode active material layer, the thermosensitive coating layer, and the positive electrode active material layer; and

(4) the positive electrode current collector, the positive electrode active material layer, the thermosensitive coating layer, (the positive electrode active material layer, the thermosensitive coating layer), . . . , the positive electrode active material layer, and the thermosensitive coating layer.

When there are a plurality of sets, components of the N thermosensitive coating layers may be the same or different, and the components and proportions thereof may be set independently.

The thermosensitive coating layer includes thermosensitive polymer microspheres, a first conductive agent, a first binder, an auxiliary agent, and an optional first positive electrode active material.

In the present disclosure, the term “optional” means that the component may or may not be included.

The N thermosensitive coating layers each may independently include the first positive electrode active material or may not include the first positive electrode active material.

In a preferred implementation, at least one of the thermosensitive coating layers includes the first positive electrode active material (it is not required that all the thermosensitive coating layers include the first positive electrode active material). In another preferred implementation, all the thermosensitive coating layers include the first positive electrode active material. When a first positive electrode active material is introduced into the thermosensitive coating layer, high safety of the positive electrode plate is maintained, and overall active material content in the positive electrode plate is also increased, thereby increasing overall energy density of the battery.

When the first positive electrode active material is not included (or in a thermosensitive coating layer without the first positive electrode active material), the thermosensitive coating layer, for example, includes components of the following weight percentages: 1.1˜95 wt % of the thermosensitive polymer microspheres, 2.9˜48.9 wt % of the first conductive agent, 2˜40 wt % of the first binder, and 0.1˜10 wt % of the auxiliary agent.

In an embodiment, the thermosensitive coating layer (without the first positive electrode active material) includes components of the following weight percentages: 20˜90 wt % of the thermosensitive polymer microspheres, 6.5˜40 wt % of the first conductive agent, 3˜30 wt % of the first binder, and 0.5˜10 wt % of the auxiliary agent.

In an embodiment, the thermosensitive coating layer (without the first positive electrode active material) includes components of the following weight percentages: 30˜80 wt % of the thermosensitive polymer microspheres, 14˜35 wt % of the first conductive agent, 5˜30 wt % of the first binder, and 1˜5 wt % of the auxiliary agent.

In an embodiment, the thermosensitive coating layer (without the first positive electrode active material) includes components of the following weight percentages: 60˜75 wt % of the thermosensitive polymer microspheres, 15˜25 wt % of the first conductive agent, 5˜15 wt % of the first binder, and 1˜5 wt % of the auxiliary agent.

When the first positive electrode active material is included (or in a thermosensitive coating layer with the first positive electrode active material), the thermosensitive coating layer, for example, includes components of the following weight percentages: 5˜90 wt % of the thermosensitive polymer microspheres, 5˜90 wt % of the first positive electrode active material, 2.9˜40 wt % of the first conductive agent, 2˜20 wt % of the first binder, and 0.1˜5 wt % of the auxiliary agent.

In an embodiment, the thermosensitive coating layer (with the first positive electrode active material) includes components of the following weight percentages: 10˜80 wt % of the thermosensitive polymer microspheres, 10˜80 wt % of the first positive electrode active material, 6.9˜30 wt % of the first conductive agent, 3˜20 wt % of the first binder, and 0.1˜5 wt % of the auxiliary agent.

In an embodiment, the thermosensitive coating layer (with the first positive electrode active material) includes components of the following weight percentages: 20˜65 wt % of the thermosensitive polymer microspheres, 20˜65 wt % of the first positive electrode active material, 10˜25 wt % of the first conductive agent, 4.5˜15 wt % of the first binder, and 0.5˜4 wt % of the auxiliary agent.

In an embodiment, the thermosensitive coating layer (with the first positive electrode active material) includes components of the following weight percentages: 65˜80 wt % of the thermosensitive polymer microspheres, 5˜15 wt % of the first positive electrode active material, 5˜15 wt % of the first conductive agent, 4.5˜15 wt % of the first binder, and 0.1˜4 wt % of the auxiliary agent.

Exemplarily, the weight percentage of the thermosensitive polymer microspheres is 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, or 90 wt %.

Exemplarily, the weight percentage of the first positive electrode active material is 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, or 90 wt %.

Exemplarily, the weight percentage of the first conductive agent is 2.9 wt %, 3 wt %, 4 wt %, 5 wt %, 8 wt %, 10 wt %, 12 wt %, 15 wt %, 18 wt %, 20 wt %, 22 wt %, 25 wt %, 28 wt %, 30 wt %, 35 wt %, or 40 wt %.

Exemplarily, the weight percentage of the first binder is 2 wt %, 4 wt %, 5 wt %, 8 wt %, 10 wt %, 12 wt %, 15 wt %, 18 wt %, or 20 wt %.

Exemplarily, the weight percentage of the auxiliary agent is 0.1 wt %, 0.5 wt %, 1 wt %, 2 wt %, 3 wt %, 4 wt %, or 5 wt %.

According to the present disclosure, components of the M positive electrode active material layers may be the same or different, and the components and proportions thereof may be set independently.

The positive electrode active material layer includes a second positive electrode active material, a second conductive agent, and a second binder.

In an embodiment, the positive electrode active material layer includes components of the following weight percentages: 80˜99 wt % of the second positive electrode active material, 0.5˜10 wt % of the second conductive agent, and 0.5˜10 wt % of the second binder.

In an embodiment, the positive electrode active material layer includes components of the following weight percentages: 84˜99 wt % of the second positive electrode active material, 0.5˜8 wt % of the second conductive agent, and 0.5˜8 wt % of the second binder.

In an embodiment, the positive electrode active material layer includes components of the following weight percentages: 90˜98 wt % of the second positive electrode active material, 1˜5 wt % of the second conductive agent, and 1˜5 wt % of the second binder.

Exemplarily, the weight percentage of the second positive electrode active material is 80 wt %, 85 wt %, 90 wt %, 95 wt %, or 99 wt %.

Exemplarily, the weight percentage of the second conductive agent is 0.5 wt %, 1 wt %, 2 wt %, 3 wt %, 4 wt %, 5 wt %, 8 wt %, or 10 wt %.

Exemplarily, the weight percentage of the second binder is 0.5 wt %, 1 wt %, 2 wt %, 3 wt %, 4 wt %, 5 wt %, 8 wt %, or 10 wt %.

According to the present disclosure, the composite fusion layer is formed by mutual permeation of the thermosensitive coating layer and the positive electrode active material layer during the preparation process, and thus components included in the composite fusion layer are a combination of components forming the thermosensitive coating layer and the positive electrode active material layer on both sides of the composite fusion layer. Therefore, the composite fusion layer includes the thermosensitive polymer microspheres, the first conductive agent, the first binder, the auxiliary agent, the second positive electrode active material, the second conductive agent, the second binder, and the optional first positive electrode active material. Similarly, mass ratios of the components in the composite fusion layer are not particularly defined, as long as the components are all included and conform to proportions of the components in the thermosensitive coating layer and the positive electrode active material layer.

According to the present disclosure, a particle size of the thermosensitive polymer microspheres ranges from 100 nm to 3 μm, and is exemplarily 100 nm, 150 nm, 200 nm, 500 nm, 1 μm, 1.5 μm, 2 μm, 2.5 μm, or 3 μm.

In an embodiment, the particle size of the thermosensitive polymer microspheres ranges from 200 nm to 2 μm.

In the present disclosure, the term “particle size” refers to a particle size range, which is measured by means of scanning electron microscopy (SEM).

According to the present disclosure, a thermosensitive temperature of the thermosensitive polymer microspheres is greater than or equal to 110° C., for example, ranges from 115° C. to 160° C., and for example, is 115° C., 120° C., 125° C., 130° C., 135° C., 140° C., 145° C., 150° C., or 160° C. The thermosensitive temperature is measured by using a differential scanning calorimeter (DSC).

The thermosensitive polymer microspheres may be purchased commercially. The thermosensitive polymer microspheres may be selected from one or more of polyethylene, polypropylene, polyamide, polyester amide, polystyrene, polyvinyl chloride, polyester, polyurethane, olefin copolymer, or a monomer-modified copolymerized polymer thereof. Exemplarily, the olefin copolymer is, for example, a propylene copolymer (such as a propylene-ethylene-acrylate copolymer, exemplarily with a mole ratio between propylene and ethylene/acrylate being (10-1):1), an ethylene copolymer (such as an ethylene-propylene copolymer, exemplarily with a mole ratio between ethylene and propylene being (10-1):1; or an ethylene-acrylate copolymer, exemplarily with a mole ratio between ethylene and acrylate being (10-1):1; or an ethylene-vinyl acetate copolymer, exemplarily with a mole ratio between ethylene and vinyl acetate being (10-1):1), or the like.

According to the present disclosure, the first positive electrode active material and the second positive electrode active material are the same or different, and are independently selected from a combination of one or more of lithium iron phosphate (LiFePO₄), lithium cobalt oxide (LiCoO₂), lithium nickel cobalt manganese oxide (Li_{z}NiₓCo_{y}Mn_{1-x-y}O₂, where 0.95≤z≤1.05, x>0, y>0, and 0<x+y<1), lithium manganate (LiMnO₂), lithium nickel cobalt aluminum oxide (Li_{z}NiₓCo_{y}Al_{1-x-y}O₂, where 0.95≤z≤1.05, x>0, y>0, and 0.8≤x+y<1), lithium nickel cobalt manganese aluminum oxide (Li_{z}NiₓCo_{y}Mn_{w}Al_{1-x-y-w}O₂, where 0.95≤z≤1.05, x>0, y>0, w>0, and 0.8≤x+y+w<1), a nickel-cobalt-aluminum-tungsten material, a lithium-rich manganese-based solid solution positive electrode material (xLi₂MnO₃.(1-x)LiMO₂, where M=Ni/Co/Mn), lithium nickel cobalt oxide (LiNiₓCo_{y}O₂, where x>0, y>0, and x+y=1), lithium nickel titanium magnesium oxide (LiNiₓTi_{y}Mg_{z}O₂, where x>0, y>0, z>0, x+y+z=1), lithium nickel oxide (Li₂NiO₂), spinel lithium manganese oxide (LiMn₂O₄), or a nickel-cobalt-tungsten material.

According to the present disclosure, the first conductive agent and the second conductive agent are the same or different, and are independently selected from one or more of conductive carbon black, ketjen black, conductive fiber, a conductive polymer, acetylene black, a carbon nanotube, graphene, flake graphite, a conductive oxide, or a metal particle.

According to the present disclosure, the first binder is selected from a water-based binder or an oil-based binder, where the water-based binder is a combination of one or more of acrylate, poly(meth)acrylic acid, styrene-butadiene rubber (SBR), polyvinyl alcohol, polyvinyl acetate, carboxymethyl cellulose (CMC), sodium carboxymethyl cellulose, carboxyethyl cellulose, water-based polyurethane, ethylene-vinyl acetate copolymer, polyacrylic copolymer, lithium polystyrene sulfonate, water-based silicone resin, nitrile-polyvinyl chloride blend, styrene-acrylic latex, pure styrene latex, etc. and blends and copolymers derived from modification of the above-mentioned polymers; and the oil-based binder is a combination of one or more of polytetrafluoroethylene (PTEF), polyvinylidene fluoride (PVDF), and polyvinylidene fluoride-hexafluoropropylene.

According to the present disclosure, the second binder is selected from a combination of one or more of polytetrafluoroethylene (PTEF), polyvinylidene fluoride (PVDF), and polyvinylidene fluoride-hexafluoropropylene.

According to the present disclosure, the auxiliary agent is selected from at least one of a dispersant or a filler, where the dispersant is at least one of branched chain alcohol, triethyl phosphate, polyethylene glycol, fluorinated polyethylene oxide, polyethylene oxide, stearic acid, sodium dodecyl benzene sulfonate, sodium hexadecyl sulfonate, fatty acid glycerides, sorbitan fatty acid esters, and polysorbates; and the filler is a nano-filler (nano-silica, aluminum oxide, zirconium dioxide, boron nitride, aluminum nitride, etc.), a nano-oxide electrolyte, or the like.

In the present disclosure, the thermosensitive coating layer may be a water-based thermosensitive coating layer or an oil-based thermosensitive coating layer, which may be selected by those skilled in the art as required. The water-based thermosensitive coating layer or the oil-based thermosensitive coating layer is implemented by selecting a water-based or oil-based solvent and a water-based or oil-based binder.

A thickness of the current collector may range from 0.1 μm to 20 μm, for example, 2 μm to 15 μm, and may be exemplarily 0.5 μm, 1 μm, 3 μm, 4 μm, 5 μm, 8 μm, 10 μm, 12 μm, or 15 μm.

A single-layer thickness of the thermosensitive coating layer may range from 0.1 μm to 5 μm, for example, 0.2 μm to 3 μm, and may be exemplarily 0.3 μm, 0.5 μm, 0.8 μm, 1 μm, 1.5 μm, 2 μm, 2.5 μm, or 3 μm.

A single-layer thickness of the composite fusion layer may range from 0.001 μm to 0.5 μm, and may be exemplarily 0.001 μm, 0.005 μm, 0.01 μm, 0.02 μm, 0.05 μm, 0.08 μm, 0.1 μm, 0.2 μm, 0.3 μm, 0.4 μm, or 0.5 μm.

A single-layer thickness of the positive electrode active material layer may range from 5 μm to 175 μm, for example, 5 μm to 65 μm, and may be exemplarily 5 μm, 10 μm, 15 μm, 20 μm, 25 μm, 30 μm, 35 μm, 40 μm, 45 μm, 50 μm, 55 μm, 60 μm, 65 μm, 70 μm, 80 μm, 90 μm, 100 μm, 120 μm, 130 μm, 140 μm, 150 μm, 160 μm, 170 μm, or 175 μm.

According to the present disclosure, a thickness of the positive electrode plate ranges from 50 μm to 200 μm, and may be exemplarily 50 μm, 55 μm, 60 μm, 65 μm, 70 μm, 80 μm, 90 μm, 100 μm, 120 μm, 130 μm, 140 μm, 150 μm, 160 μm, 170 μm, 180 μm, 190 μm, or 200 μm.

According to the present disclosure, a resistance of the positive electrode plate is less than 10Ω, and is preferably less than 500 mΩ.

According to the present disclosure, in the thermosensitive coating layer, a sum of volumes of the thermosensitive polymer microspheres accounts for 1.1% to 95%, for example, 2%, 5%, 10%, 15%, 20%, 25%, 30%, 35%, 40%, 45%, 50%, 55%, 60%, 65%, 70%, 75%, 80%, 85%, 90%, or 95% of a total volume of the thermosensitive coating layer.

In an embodiment, in the thermosensitive coating layer, the sum of the volumes of the thermosensitive polymer microspheres accounts for 35˜85% of the total volume of the thermosensitive coating layer.

A second aspect of the present disclosure further provides a method for preparing the positive electrode plate described above. The method includes the following steps:

(1) performing first mixing on a first solvent, thermosensitive polymer microspheres, a first conductive agent, a first binder, an auxiliary agent, and an optional first positive electrode active material, to obtain thermosensitive coating layer slurry;

(2) performing second mixing on a second solvent, a second positive electrode active material, a second conductive agent, and a second binder, to obtain positive electrode active material layer slurry; and

(3) successively and alternately applying the thermosensitive coating layer slurry obtained in step (1) or the positive electrode active material layer slurry obtained in step (2) on a surface of a positive electrode current collector, and drying to obtain the positive electrode plate.

The first solvent and the second solvent each are independently selected from a water-based solvent or an oil-based solvent, where the water-based solvent is, for example, water; and the oil-based solvent is, for example, selected from at least one of N-methylpyrrolidone, hydrofluoroether, acetone, tetrahydrofuran, dichloromethane, or pyridine.

A condition for the drying, for example, includes: 12 to 72 hours at a temperature lower than the thermosensitive temperature (e.g., 80° C. to 110° C.) of the thermosensitive polymer microspheres.

During preparation of the water-based thermosensitive coating layer, the first solvent may be a water-based solvent, and the first binder may be a water-based binder.

During preparation of the oil-based thermosensitive coating layer, the first solvent may be an oil-based solvent, and the first binder may be an oil-based binder.

According to a specific implementation, the method for preparing a positive electrode plate includes the following steps:

(1) performing first mixing on 200 to 1000 parts by mass of a first solvent, 5 to 90 parts by mass of thermosensitive polymer microspheres, 2.9 to 40 parts by mass of a first conductive agent, 2 to 20 parts by mass of a first binder, 0.1 to 5 parts by mass of an auxiliary agent, and 5 to 90 parts by mass of an optional first positive electrode active material, to obtain thermosensitive coating layer slurry;

(2) performing second mixing on 200 to 1000 parts by mass of a second solvent, 80 to 99 parts by mass of a second positive electrode active material, 0.5 to 1 part by mass of a second conductive agent, and 0.5 to 10 parts by mass of a second binder, to obtain positive electrode active material layer slurry; and

(3) successively and alternately applying the thermosensitive coating layer slurry obtained in step (1) or the positive electrode active material layer slurry obtained in step (2) on a surface of a positive electrode current collector, and drying at 80° C. to 110° C. for 12 to 72 hours to obtain the positive electrode plate.

In step (1), the first mixing includes: first mixing the components other than the thermosensitive polymer microspheres, screening the mixed components through a sieve (for example, a 100-mesh sieve, which is used to screen out agglomerated particles) and then mixing the screened components with the thermosensitive polymer microspheres, and screening the mixed components and thermosensitive polymer microspheres through the sieve (for example, 100-mesh) again to obtain the thermosensitive coating layer slurry.

Step (3) further includes performing the drying once each time one thermosensitive coating layer or positive electrode active material layer has been applied.

With the foregoing preparation method, the positive electrode plate described in the first aspect can be obtained. The properties of the positive electrode plate are the same as those described in the first aspect, and details are not repeated herein.

A third aspect of the present disclosure further provides a battery, the battery including the positive electrode plate described above.

In an embodiment, the battery is a secondary battery.

In an embodiment, the battery is a lithium-ion battery.

According to the present disclosure, when a capacity retention of the battery decreases to 80% at 25° C. and a 1C/1C charge-discharge regime, a number of cycles is greater than or equal to 1100.

Herein, the terms containing ordinal numbers such as “first” and “second” are merely used to distinguish between different substances and/or different use environments, and do not indicate or imply order or relative importance.

The positive electrode plate of the present disclosure includes a positive electrode current collector, at least one thermosensitive coating layer, at least one composite fusion layer, and at least one positive electrode active material layer. The thermosensitive coating layer and the positive electrode active material layer are successively provided on the surface of the positive electrode current collector, and the composite fusion layer is provided between the thermosensitive coating layer and the positive electrode active material layer. The thermosensitive coating layer has electrical conductivity at room temperature, and has the advantages of increasing a contact area between the active material and the current collector, effectively reducing battery polarization, and the like. When a first positive electrode active material is introduced into the thermosensitive coating layer, high safety of the positive electrode plate is maintained, and overall active material content in the positive electrode plate is also increased, thereby increasing overall energy density of the battery. When a temperature of the positive electrode plate during use reaches a thermosensitive temperature and higher, thermosensitive polymer microspheres melt to form at least one continuous electron blocking layer, such that the coating layer forms a current blockage, and an internal blockage is formed inside the battery (as shown in FIG. 2 and FIG. 4), thereby preventing further thermal runaway of the secondary battery, and improving the safety performance of the secondary battery. The positive electrode plate of the present disclosure has good compatibility with a solvent. The battery obtained has a low resistance, and the battery has good cycling performance. In addition, the battery has a good PTC effect during thermal runaway, and an excellent thermal blockage can be achieved.

The present disclosure is further described in detail below with reference to specific embodiments. It should be understood that the following embodiments are merely for the purposes of illustrating and explaining the present disclosure, and should not be construed as limiting the scope of protection of the present disclosure. Any technology implemented based on the foregoing contents of the present disclosure falls within the intended scope of protection of the present disclosure.

Experimental methods used in the following examples are conventional methods, unless otherwise specified. Reagents, materials, and the like used in the following examples are all commercially available, unless otherwise specified.

Thermosensitive polymer microspheres used in the following examples were all purchased commercially.

### Example 1

S1: Formulation of thermosensitive coating layer slurry: 1000 g of N-methylpyrrolidone, 26 g of lithium cobalt oxide, 13 g of carbon nanotubes, 15 g of polyvinylidene fluoride, and 7 g of triethyl phosphate were uniformly mixed and then screened through a 100-mesh sieve, and 39 g of polyethylene thermosensitive polymer microspheres was added and uniformly mixed and then screened through the 100-mesh sieve, to obtain the thermosensitive coating layer slurry.

S2: Formulation of positive electrode slurry: 1000 g of N-methylpyrrolidone, 99 g of lithium cobalt oxide, 0.5 g of polyvinylidene fluoride, and 0.5 g of carbon nanotubes were uniformly mixed, to obtain the positive electrode coating layer slurry.

S3: Preparation of a positive electrode plate: The thermosensitive coating layer slurry in S1 was applied on a surface of an aluminum foil current collector, and after drying at 110° C. for 12 hours, the current collector with a thermosensitive coating layer (referred to as a first layer) on the surface was obtained. The positive electrode coating layer slurry in S2 was applied on the surface of the current collector with the thermosensitive coating layer on the surface. After drying at 110° C. for 12 hours, pressing, and cutting, the positive electrode plate with a positive electrode active material layer (referred to as a second layer) and the thermosensitive coating layer (referred to as the first layer) on the surface was obtained. The thermosensitive coating layer and the positive electrode active material layer permeated with each other during the drying and pressing processes to form a composite fusion layer, and a thickness of composite fusion layer may be observed by means of scanning electron microscopy and EDS energy dispersive spectroscopy.

S4: Preparation of a negative electrode plate: 400 g of deionized water, 97 g of graphite, 0.5 g of conductive carbon black, 1 g of CMC, and 1.5 g of styrene-butadiene rubber were uniformly mixed, then applied on a negative electrode current collector, and then dried. The drying process is a conventional process in the industry.

S5: Preparation of a lithium-ion battery: The positive electrode, the negative electrode, and a separator were stacked or wound to prepare a lithium-ion battery cell, and a high-safety lithium-ion battery was obtained after baking, electrolyte filling, formation, and packaging.

### Examples 2 to 12 and Comparative Examples 1 and 2

Preparation processes of Examples 2 to 12 and Comparative Examples 1 and 2 are the same as that of Example 1, both of which are prepared by using a multi-layer coating method, except that the composition of the thermosensitive coating layer slurry in step S1 is different, the composition of the positive electrode slurry in step S2 is different, and the sequence of the slurries applied on the surface of the positive electrode current collector in step S3 is different, specifically as shown in Table 1 (including Table 1-1 and Table 1-2) and Table 2 (including Table 2-1 and Table 2-2). A layer in direct contact with the positive electrode current collector is referred to as a first layer, with the following layers referred to as a second layer, a third layer, and so on.

Specifically, batteries of Example 2, Example 4, and Example 5 were prepared by stacking, and batteries of Example 1, Example 3, Examples 6 to 12, and Comparative Examples 1 and 2 were prepared by winding.

2. Experimental Data

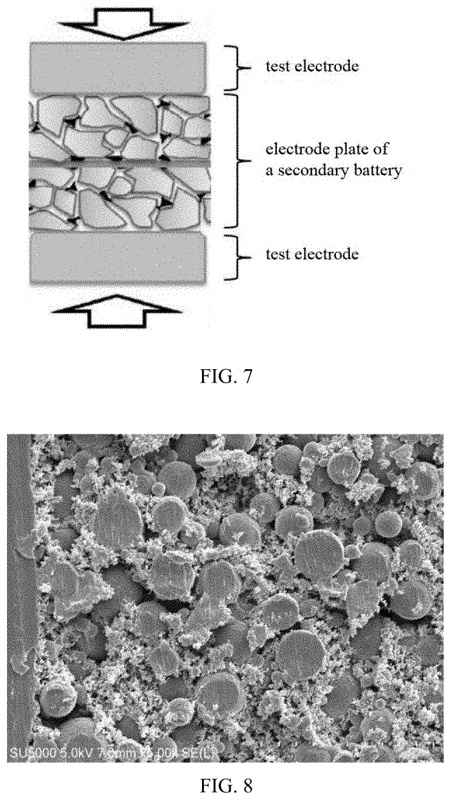

Electrode plate resistance test: An ACCFILM diaphragm resistance test instrument used a pressure-controllable two-probe resistance to directly test an overall resistance of the electrode plate (a schematic diagram of the test is shown in FIG. 7), and an output measurement value was a resistance of the electrode plate.

The test process was as follows: An appropriate surface flatness was designed for the probes, and a pressure of 10 N was applied for testing. The test apparatus was placed in an oven, an initial temperature of the oven was 20° C., the temperature was increased to 145° C. at a heating rate of 2° C./min, and data was recorded in real time.

Test method of a battery internal resistance by alternating current (AC) impedance: An AC impedance test was performed on a lithium-ion battery in the range of 100 Khz to 0.1 mHz and at 250° C. by a Metrohm PGSTAT302N chemical workstation.

Test method of cycling performance of the battery: A charge/discharge cycle test for the lithium-ion battery was performed on a LAND battery charge/discharge test cabinet. The test conditions were 25° C., 50% humidity, and 1C/1C charge and discharge.

Thermal test for the battery: States of the battery at different temperatures were detected by using an adiabatic accelerating rate calorimeter of PhiTEC I (ARC) model from the British HEL brand.

TABLE 1
Addition amount and drying condition of the thermosensitive coating layer
slurry in the examples and the comparative examples

| | | | | | Positive | |
|---|---|---|---|---|---|---|
| | | | | Thermosensitive | electrode | |
| | | | | polymer | active | Conductive |
| Number | Layer structure | Slurry | Solvent/g | microspheres/g | material/g | agent/g |
| Example 1 | First layer | Thermosensitive | 1000 | 39 | 26 | 13 |
| | | slurry | | | | |
| | Second layer | Positive | 1000 | — | 99 | 0.5 |
| | | electrode slurry | | | | |
| Example 2 | First layer | Positive | 200 | — | 80 | 10 |
| | | electrode slurry | | | | |
| | Second layer | Thermosensitive | 200 | 5 | 90 | 2.9 |
| | | slurry | | | | |
| Example 3 | First layer | Positive | 900 | — | 85 | 8 |
| | | electrode slurry | | | | |
| | Second layer | Thermosensitive | 400 | 70 | 20 | 5 |
| | | slurry | | | | |
| | Third layer | Positive | 600 | — | 95 | 3 |
| | | electrode slurry | | | | |
| Example 4 | First layer | Thermosensitive | 800 | 50 | 30 | 25 |
| | | slurry | | | | |
| | Second layer | Positive | 600 | — | 97 | 1.5 |
| | | electrode slurry | | | | |
| | Third layer | Thermosensitive | 700 | 80 | 10 | 6 |
| | | slurry | | | | |
| Example 5 | First layer | Thermosensitive | 500 | 60 | 20 | 10 |
| | | slurry | | | | |
| | Second layer | Positive | 700 | — | 85 | 7 |
| | | electrode slurry | | | | |
| | Third layer | Thermosensitive | 800 | 40 | 30 | 15 |
| | | slurry | | | | |
| | Fourth layer | Positive | 500 | — | 96 | 2 |
| | | electrode slurry | | | | |
| Example 6 | First layer | Positive | 900 | — | 90 | 5 |
| | | electrode slurry | | | | |
| | Second layer | Thermosensitive | 600 | 37 | 40 | 11 |
| | | slurry | | | | |
| | Third layer | Positive | 700 | — | 85 | 10 |
| | | electrode slurry | | | | |
| | Fourth layer | Thermosensitive | 800 | 50 | 30 | 4 |
| | | slurry | | | | |
| Example 7 | First layer | Thermosensitive | 600 | 40 | 45 | 8 |
| | | slurry | | | | |
| | Second layer | Positive | 600 | — | 92 | 4 |
| | | electrode slurry | | | | |
| Example 8 | First layer | Thermosensitive | 500 | 55 | 30 | 5 |
| | | slurry | | | | |
| | Second layer | Positive | 700 | — | 94 | 3 |
| | | electrode slurry | | | | |
| Example 9 | First layer | Thermosensitive | 400 | 75 | 10 | 10 |
| | | slurry | | | | |
| | Second layer | Positive | 600 | — | 88 | 7 |
| | | electrode slurry | | | | |
| Example 10 | First layer | Thermosensitive | 400 | 75 | 10 | 10 |
| | | slurry | | | | |
| | Second layer | Positive | 600 | — | 88 | 7 |
| | | electrode slurry | | | | |
| Example 11 | First layer | Thermosensitive | 400 | 75 | 10 | 10 |
| | | slurry | | | | |
| | Second layer | Positive | 600 | — | 88 | 7 |
| | | electrode slurry | | | | |
| Example 12 | First layer | Thermosensitive | 400 | 75 | 10 | 10 |
| | | slurry | | | | |
| | Second layer | Positive | 600 | — | 88 | 7 |
| | | electrode slurry | | | | |
| Example 13 | First layer | Thermosensitive | 600 | 70 | 0 | 20 |
| | | slurry | | | | |
| | Second layer | Positive | 500 | — | 96 | 2 |
| | | electrode slurry | | | | |
| Example 14 | First layer | Thermosensitive | 400 | 10 | 10 | 10 |
| | | slurry | | | | |
| | Second layer | Positive | 600 | — | 88 | 7 |
| | | electrode slurry | | | | |
| Example 15 | First layer | Thermosensitive | 400 | 20 | 65 | 10 |
| | | slurry | | | | |
| | Second layer | Positive | 600 | — | 88 | 7 |
| | | electrode slurry | | | | |
| Example 16 | First layer | Thermosensitive | 400 | 75 | 10 | 10 |
| | | slurry | | | | |
| | Second layer | Positive | 600 | — | 88 | 7 |
| | | electrode slurry | | | | |
| | Third layer | Thermosensitive | 400 | 75 | 10 | 10 |
| | | slurry | | | | |
| | Fourth layer | Positive | 600 | — | 88 | 7 |
| | | electrode slurry | | | | |
| Example 17 | First layer | Thermosensitive | 400 | 75 | 10 | 10 |
| | | slurry | | | | |
| | Second layer | Positive | 600 | — | 88 | 7 |
| | | electrode slurry | | | | |
| Example 18 | First layer | Thermosensitive | 400 | 75 | 10 | 10 |
| | | slurry | | | | |
| | Second layer | Positive | 600 | — | 88 | 7 |
| | | electrode slurry | | | | |
| Comparative | One layer | Positive | 600 | — | 88 | 7 |
| Example 1 | | electrode slurry | | | | |
| Comparative | First layer | Coating layer | 400 | — | 10 | 10 |
| Example 2 | | without | | | | |
| | | microspheres | | | | |
| | Second layer | Positive | 600 | — | 88 | 7 |
| | | electrode slurry | | | | |
| | | | | Auxiliary | Drying | Drying |
| Number | Layer structure | Slurry | Binder/g | agent/g | temperature/° C. | time/h |
| Example 1 | First layer | Thermosensitive | 15 | 7 | 110 | 12 |
| | | slurry | | | | |
| | Second layer | Positive | 0.5 | — | 110 | 12 |
| | | electrode slurry | | | | |
| Example 2 | First layer | Positive | 10 | — | 80 | 72 |
| | | electrode slurry | | | | |
| | Second layer | Thermosensitive | 2 | 0.1 | 80 | 72 |
| | | slurry | | | | |
| Example 3 | First layer | Positive | 7 | — | 100 | 18 |
| | | electrode slurry | | | | |
| | Second layer | Thermosensitive | 4 | 1 | 90 | 20 |
| | | slurry | | | | |
| | Third layer | Positive | 2 | — | 85 | 40 |
| | | electrode slurry | | | | |
| Example 4 | First layer | Thermosensitive | 4 | 1 | 100 | 24 |
| | | slurry | | | | |
| | Second layer | Positive | 1.5 | — | 95 | 36 |
| | | electrode slurry | | | | |
| | Third layer | Thermosensitive | 3.5 | 0.5 | 85 | 16 |
| | | slurry | | | | |
| Example 5 | First layer | Thermosensitive | 5 | 5 | 100 | 30 |
| | | slurry | | | | |
| | Second layer | Positive | 8 | — | 85 | 32 |
| | | electrode slurry | | | | |
| | Third layer | Thermosensitive | 12 | 3 | 100 | 48 |
| | | slurry | | | | |
| | Fourth layer | Positive | 2 | — | 90 | 60 |
| | | electrode slurry | | | | |
| Example 6 | First layer | Positive | 5 | — | 99 | 24 |
| | | electrode slurry | | | | |
| | Second layer | Thermosensitive | 9 | 3 | 85 | 60 |
| | | slurry | | | | |
| | Third layer | Positive | 5 | — | 110 | 48 |
| | | electrode slurry | | | | |
| | Fourth layer | Thermosensitive | 4 | 2 | 100 | 24 |
| | | slurry | | | | |
| Example 7 | First layer | Thermosensitive | 6.9 | 0.1 | 88 | 28 |
| | | slurry | | | | |
| | Second layer | Positive | 4 | — | 105 | 40 |
| | | electrode slurry | | | | |
| Example 8 | First layer | Thermosensitive | 9.5 | 0.5 | 100 | 40 |
| | | slurry | | | | |
| | Second layer | Positive | 3 | — | 100 | 36 |
| | | electrode slurry | | | | |
| Example 9 | First layer | Thermosensitive | 4.8 | 0.2 | 95 | 36 |
| | | slurry | | | | |
| | Second layer | Positive | 5 | — | 108 | 32 |
| | | electrode slurry | | | | |
| Example 10 | First layer | Thermosensitive | 4.8 | 0.2 | 95 | 36 |
| | | slurry | | | | |
| | Second layer | Positive | 5 | — | 108 | 32 |
| | | electrode slurry | | | | |
| Example 11 | First layer | Thermosensitive | 4.8 | 0.2 | 95 | 36 |
| | | slurry | | | | |
| | Second layer | Positive | 5 | — | 108 | 32 |
| | | electrode slurry | | | | |
| Example 12 | First layer | Thermosensitive | 4.8 | 0.2 | 95 | 36 |
| | | slurry | | | | |
| | Second layer | Positive | 5 | — | 108 | 32 |
| | | electrode slurry | | | | |
| Example 13 | First layer | Thermosensitive | 8 | 2 | 100 | 48 |
| | | slurry | | | | |
| | Second layer | Positive | 2 | — | 80 | 72 |
| | | electrode slurry | | | | |
| Example 14 | First layer | Thermosensitive | 4.8 | 0.2 | 95 | 36 |
| | | slurry | | | | |
| | Second layer | Positive | 5 | — | 108 | 32 |
| | | electrode slurry | | | | |
| Example 15 | First layer | Thermosensitive | 4.8 | 0.2 | 95 | 36 |
| | | slurry | | | | |
| | Second layer | Positive | 5 | — | 108 | 32 |
| | | electrode slurry | | | | |
| Example 16 | First layer | Thermosensitive | 4.8 | 0.2 | 95 | 36 |
| | | slurry | | | | |
| | Second layer | Positive | 5 | — | 108 | 32 |
| | | electrode slurry | | | | |
| | Third layer | Thermosensitive | 4.8 | 0.2 | 95 | 36 |
| | | slurry | | | | |
| | Fourth layer | Positive | 5 | — | 108 | 32 |
| | | electrode slurry | | | | |
| Example 17 | First layer | Thermosensitive | 4.8 | 0.2 | 95 | 36 |
| | | slurry | | | | |
| | Second layer | Positive | 5 | — | 108 | 32 |
| | | electrode slurry | | | | |
| Example 18 | First layer | Thermosensitive | 4.8 | 0.2 | 95 | 36 |
| | | slurry | | | | |
| | Second layer | Positive | 5 | — | 108 | 32 |
| | | electrode slurry | | | | |
| Comparative | One layer | Positive | 5 | — | 108 | 32 |
| Example 1 | | electrode slurry | | | | |
| Comparative | First layer | Coating layer without | 4.8 | 0.2 | 95 | 36 |
| Example 2 | | microspheres | | | | |
| | Second layer | Positive | 5 | — | 108 | 32 |
| | | electrode slurry | | | | |

TABLE 2-1
Composition of the thermosensitive coating layer slurry in the examples and the comparative examples

| | | | | Thermosensitive polymer | |
|---|---|---|---|---|---|
| | | | | microspheres type and | |
| | Layer | | | thermosensitive | Positive electrode |
| Number | structure | Slurry | Solvent type | temperature | active material |
| Example 1 | First | Thermosensitive | Hydrofluoroether | Polyethylene (135° C.) | Lithium iron |
| | layer | slurry | | | phosphate |
| | Second | Positive | NMP | — | Lithium cobalt oxide |
| | layer | electrode slurry | | | |
| Example 2 | First | Positive | NMP | — | Nickel-cobalt-- |
| | layer | electrode slurry | | | manganese ternary |
| | | | | | material |
| | Second | Thermosensitive | Water | Polypropylene (125° C.) | Lithium iron |
| | layer | slurry | | | phosphate |
| Example 3 | First | Positive | NMP | — | Lithium cobalt oxide |
| | layer | electrode slurry | | | |
| | Second | Thermosensitive | Acetone | Ethylene-propylene | Lithium iron |
| | layer | slurry | | copolymer (ethylene- | phosphate |
| | | | | propylene monomer mole | |
| | | | | ratio 3:1) (125° C.) | |
| | Third | Positive | NMP | — | Lithium cobalt oxide |
| | layer | electrode slurry | | | |
| Example 4 | First | Thermosensitive | DMF | Ethylene-propylene | Lithium iron |
| | layer | slurry | | copolymer (ethylene- | phosphate |
| | | | | propylene monomer mole | |
| | | | | ratio 3:1) (125° C.) | |
| | Second | Positive | NMP | — | Nickel-cobalt-- |
| | layer | electrode slurry | | | aluminum ternary |
| | | | | | material |
| | Third | Thermosensitive | Hydrofluoroether | Ethylene-acrylate | Nickel-cobalt-- |
| | layer | slurry | | copolymer (ethylene- | aluminum ternary |
| | | | | acrylate monomer mole | material |
| | | | | ratio 6:1) (120° C.) | |
| Example 5 | First | Thermosensitive | Acetone | Polyethylene (140° C.) | Lithium iron |
| | layer | slurry | | | phosphate |
| | Second | Positive | NMP | — | Nickel-cobalt-- |
| | layer | electrode slurry | | | manganese ternary |
| | | | | | material |
| | Third | Thermosensitive | Acetone | Ethylene-propylene | Nickel-cobalt-- |
| | layer | slurry | | copolymer (ethylene- | manganese ternary |
| | | | | propylene monomer mole | material |
| | | | | ratio 5:1) (130° C.) | |
| | Fourth | Positive | NMP | — | Nickel-cobalt-- |
| | layer | electrode slurry | | | manganese ternary |
| | | | | | material |
| Example 6 | First | Positive | NMP | — | Lithium cobalt oxide |
| | layer | electrode slurry | | | |
| | Second | Thermosensitive | DMF | Polypropylene | Lithium cobalt oxide |
| | layer | slurry | | (147° C.) | |
| | Third | Positive | NMP | — | Lithium cobalt oxide |
| | layer | electrode slurry | | | |
| | Fourth | Thermosensitive | Acetone | Propylene-ethylene-- | Lithium cobalt oxide |
| | layer | slurry | | acrylate copolymer | |
| | | | | (propylene-ethylene-- | |
| | | | | acrylate monomer mole | |
| | | | | ratio 1:1:1) (125° C.) | |
| Example 7 | First | Thermosensitive | Hydrofluoroether | Propylene-ethylene-- | Nickel-cobalt-- |
| | layer | slurry | | acrylate copolymer | aluminum ternary |
| | | | | (propylene-ethylene-- | material |
| | | | | acrylate monomer | |
| | | | | mole ratio 2:1:1) | |
| | | | | (135° C.) | |
| | Second | Positive | NMP | — | Lithium cobalt oxide |
| | layer | electrode slurry | | | |
| Example 8 | First | Thermosensitive | Water | Ethylene-propylene | Nickel-cobalt-- |
| | layer | slurry | | copolymer (ethylene- | manganese ternary |
| | | | | propylene monomer mole | material |
| | | | | ratio 5:1) (125° C.) | |
| | Second | Positive | NMP | — | Lithium cobalt oxide |
| | layer | electrode slurry | | | |
| Example 9 | First | Thermosensitive | Hydrofluoroether | Polyethylene (120° C.) | Lithium cobalt oxide |
| | layer | slurry | | | |
| | Second | Positive | NMP | — | Lithium cobalt oxide |
| | layer | electrode slurry | | | |
| Example 10 | First | Thermosensitive | Hydrofluoroether | Polyethylene (120° C.) | Lithium cobalt oxide |
| | layer | slurry | | | |
| | Second | Positive | NMP | — | Lithium cobalt oxide |
| | layer | electrode slurry | | | |
| Example 11 | First | Thermosensitive | Hydrofluoroether | Polyethylene (120° C.) | Lithium cobalt oxide |
| | layer | slurry | | | |
| | Second | Positive | NMP | — | Lithium cobalt oxide |
| | layer | electrode slurry | | | |
| Example 12 | First | Thermosensitive | Hydrofluoroether | Polyethylene (120° C.) | Lithium cobalt oxide |
| | layer | slurry | | | |
| | Second | Positive | NMP | — | Lithium cobalt oxide |
| | layer | electrode slurry | | | |
| Example 13 | First | Thermosensitive | Water | Polyethylene (120° C.) | — |
| | layer | slurry | | | |
| | Second | Positive | NMP | — | Lithium cobalt oxide |
| | layer | electrode slurry | | | |
| Example 14 | First | Thermosensitive | Hydrofluoroether | Polyethylene (120° C.) | Lithium cobalt oxide |
| | layer | slurry | | | |
| | Second | Positive | NMP | — | Lithium cobalt oxide |
| | layer | electrode slurry | | | |
| Example 15 | First | Thermosensitive | Hydrofluoroether | Polyethylene (120° C.) | Lithium cobalt oxide |
| | layer | slurry | | | |
| | Second | Positive | NMP | — | Lithium cobalt oxide |
| | layer | electrode slurry | | | |
| Example 16 | First | Thermosensitive | Hydrofluoroether | Polyethylene (120° C.) | Lithium cobalt oxide |
| | layer | slurry | | | |
| | Second | Positive | NMP | — | Lithium cobalt oxide |
| | layer | electrode slurry | | | |
| | Third | Thermosensitive | Hydrofluoroether | Polyethylene (120° C.) | Lithium cobalt oxide |
| | layer | slurry | | | |
| | Fourth | Positive | NMP | — | Lithium cobalt oxide |
| | layer | electrode slurry | | | |
| Example 17 | First | Thermosensitive | Hydrofluoroether | Polyethylene (125° C.) | Lithium cobalt oxide |
| | layer | slurry | | | |
| | Second | Positive | NMP | — | Lithium cobalt oxide |
| | layer | electrode slurry | | | |
| Example 18 | First | Thermosensitive | Hydrofluoroether | Polyethylene and | Lithium cobalt oxide |
| | layer | slurry | | polypropylene mixed 1:1 | |
| | | | | by weight (115° C.) | |
| | Second | Positive | NMP | — | Lithium cobalt oxide |
| | layer | electrode slurry | | | |
| Comparative | One | Positive | NMP | — | Lithium cobalt oxide |
| Example 1 | layer | electrode slurry | | | |
| Comparative | First | Coating layer | Hydrofluoroether | — | Lithium cobalt oxide |
| | layer | without | | | |
| | | microspheres | | | |
| Example 2 | Second | Positive | NMP | — | Lithium cobalt oxide |
| | layer | electrode slurry | | | |

Table 2-2 Composition of the thermosensitive coating layer slurry in the examples and the comparative examples

| | Layer | | | | Auxiliary agent |
|---|---|---|---|---|---|
| Number | structure | Slurry | Conductive agent | Binder | type |
| Example 1 | First layer | Thermosensitive | Carbon nanotubes | Polyacrylate | Polyethylene |
| | | slurry | | | glycol:alumina (2:3) |
| | Second | Positive electrode | Carbon nanotubes | PVDF | — |
| | layer | slurry | | | |
| Example 2 | First layer | Positive electrode | Conductive carbon | PTEF | — |
| | | slurry | black:graphene (1:2) | | |
| | Second | Thermosensitive | Graphene:carbon | Styrene-butadiene | Polyethylene |
| | layer | slurry | nanotubes (1:4) | rubber:carboxymethylc | glycol |
| | | | | ellulose (1:1) | |
| Example 3 | First layer | Positive electrode | Conductive carbon | PVDF | — |
| | | slurry | black:carbon | | |
| | | | nanotubes (1:1) | | |
| | Second | Thermosensitive | Conductive carbon | Polytetrafluoroethylene- | Fatty acid |
| | layer | slurry | black:carbon | hexafluoropropylene | glycerides:silica |
| | | | nanotubes (1:1) | | (1:1) |
| | Third layer | Positive electrode | Conductive carbon | PTEF | — |
| | | slurry | black:carbon | | |
| | | | nanotubes (1:1) | | |
| Example 4 | First layer | Thermosensitive | Graphene:conductive | PTEF | Triethyl |
| | | slurry | carbon black (1:3) | | phosphate: |
| | | | | | zirconium |
| | | | | | dioxide (1:1) |
| | Second | Positive electrode | Graphene:conductive | PVDF | — |
| | layer | slurry | carbon black (1:3) | | |
| | Third layer | Thermosensitive | Graphene:conductive | PTEF | Polyethylene |
| | | slurry | carbon black (1:3) | | glycol:zirconium |
| | | | | | dioxide (1:1) |
| Example 5 | First layer | Thermosensitive | Graphene:carbon | Polytetrafluoroethylene- | Stearic |
| | | slurry | nanotubes (1:1) | hexafluoropropylene | acid:silica (1:1) |
| | Second | Positive electrode | Graphene:carbon | PTEF | — |
| | layer | slurry | nanotubes (1:1) | | |
| | Third layer | Thermosensitive | Graphene:carbon | Polytetrafluoroethylene- | Branched chain |
| | | slurry | nanotubes (1:1) | hexafluoropropylene | alcohol: |
| | | | | | aluminum nitride |
| | | | | | (1:1) |
| | Fourth | Positive electrode | Graphene:carbon | PVDF | — |
| | layer | slurry | nanotubes (1:1) | | |
| Example 6 | First layer | Positive electrode | Conductive carbon | PTEF | — |
| | | slurry | black:carbon | | |
| | | | nanotubes (1:2) | | |
| | Second | Thermosensitive | Conductive carbon | PTEF | Sodium |
| | layer | slurry | black:carbon | | dodecylbenzene |
| | | | nanotubes (1:2) | | sulfonate:boron |
| | | | | | nitride (1:1) |
| | Third layer | Positive electrode | Conductive carbon | PVDF | — |
| | | slurry | black:carbon | | |
| | | | nanotubes (1:2) | | |
| | Fourth | Thermosensitive | Conductive carbon | PTEF | Fatty acid |
| | layer | slurry | black:carbon | | glycerides:nano- |
| | | | nanotubes (1:2) | | oxide electrolyte |
| | | | | | (1:1) |
| Example 7 | First layer | Thermosensitive | Carbon nanotubes | Polyacrylate | Polyethylene |
| | | slurry | | | glycol |
| | Second | Positive electrode | Carbon nanotubes | PVDF | — |
| | layer | slurry | | | |
| Example 8 | First layer | Thermosensitive | Carbon nanotubes | Polyacrylate | Polyethylene |
| | | slurry | | | glycol |
| | Second | Positive electrode | Carbon nanotubes | PVDF | — |
| | layer | slurry | | | |
| Example 9 | First layer | Thermosensitive | Conductive carbon | Polyacrylate | Polyethylene |
| | | slurry | black | | glycol |
| | Second | Positive electrode | Conductive carbon | PVDF | — |
| | layer | slurry | black | | |
| Example 10 | First layer | Thermosensitive | Conductive carbon | Polyacrylate | Polyethylene |
| | | slurry | black | | glycol |
| | Second | Positive electrode | Conductive carbon | PVDF | — |
| | layer | slurry | black | | |
| Example 11 | First layer | Thermosensitive | Conductive carbon | Polyacrylate | Polyethylene |
| | | slurry | black | | glycol |
| | Second | Positive electrode | Conductive carbon | PVDF | — |
| | layer | slurry | black | | |
| Example 12 | First layer | Thermosensitive | Conductive carbon | Polyacrylate | Polyethylene |
| | | slurry | black | | glycol |
| | Second | Positive electrode | Conductive carbon | PVDF | — |
| | layer | slurry | black | | |
| Example 13 | First layer | Thermosensitive | Conductive carbon | Styrene-butadiene | Polyethylene |
| | | slurry | black | rubber: | glycol |
| | | | | carboxymethylcellulose | |
| | | | | (mass ratio 1:1) | |
| | Second | Positive electrode | Conductive carbon | PVDF | — |
| | layer | slurry | black | | |
| Example 14 | First layer | Thermosensitive | Conductive carbon | Polyacrylate | Polyethylene |
| | | slurry | black | | glycol |
| | Second | Positive electrode | Conductive carbon | PVDF | — |
| | layer | slurry | black | | |
| Example 15 | First layer | Thermosensitive | Conductive carbon | Polyacrylate | Polyethylene |
| | | slurry | black | | glycol |
| | Second | Positive electrode | Conductive carbon | PVDF | — |
| | layer | slurry | black | | |
| Example 16 | First layer | Thermosensitive | Conductive carbon | Polyacrylate | Polyethylene |
| | | slurry | black | | glycol |
| | Second | Positive electrode | Conductive carbon | PVDF | — |
| | layer | slurry | black | | |
| | Third layer | Thermosensitive | Conductive carbon | Polyacrylate | Polyethylene |
| | | slurry | black | | glycol |
| | Fourth | Positive electrode | Conductive carbon | PVDF | — |
| | layer | slurry | black | | |
| Example 17 | First layer | Thermosensitive | Conductive carbon | Polyacrylate | Polyethylene |
| | | slurry | black | | glycol |
| | Second | Positive electrode | Conductive carbon | PVDF | — |
| | layer | slurry | black | | |
| Example 18 | First layer | Thermosensitive | Conductive carbon | Polyacrylate | Polyethylene |
| | | slurry | black | | glycol |
| | Second | Positive electrode | Conductive carbon | PVDF | — |
| | layer | slurry | black | | |
| Comparative | One layer | Positive electrode | Conductive carbon | PVDF | — |
| Example 1 | | slurry | black | | |
| Comparative | First layer | Coating layer | Conductive carbon | Polyacrylate | Polyethylene |
| | | without | black | | glycol |
| | | microspheres | | | |
| Example 2 | Second | Positive electrode | Conductive carbon | PVDF | — |
| | layer | slurry | black | | |

TABLE 3
Structure of the positive electrode plate in the examples and the
comparative examples

| | Current | Thickness of each | Composite | Thickness of |
|---|---|---|---|---|
| | collector | thermosensitive | fusion layer | each positive |
| | thickness/ | coating | thickness/ | electrode |
| Number | (μm) | layer/(μm) | (μm) | layer/(μm) |
| Example 1 | 15 | 2.5 | 0.5 | 50 |
| Example 2 | 20 | 5 | 0.5 | 175 |
| Example 3 | 10 | 0.1 | 0.01 | 35 |
| Example 4 | 8 | 5 | 0.5 | 45 |
| Example 5 | 5 | 1 | 0.4 | 80 |
| Example 6 | 2 | 2 | 0.1 | 60 |
| Example 7 | 9 | 4 | 0.005 | 45 |
| Example 8 | 10 | 0.5 | 0.5 | 50 |
| Example 9 | 16 | 5 | 0.001 | 70 |
| Example 10 | 10 | 3 | 0.01 | 50 |
| Example 11 | 10 | 3 | 0.01 | 60 |
| Example 12 | 10 | 1 | 0.5 | 50 |
| Example 13 | 10 | 3 | 0.01 | 50 |
| Example 14 | 10 | 3 | 0.01 | 50 |
| Example 15 | 10 | 3 | 0.01 | 50 |
| Example 16 | 10 | 1.5 | 0.01 | 25 |
| Example 17 | 10 | 3 | 0.01 | 50 |
| Example 18 | 10 | 3 | 0.01 | 50 |
| Comparative | 10 | — | — | 50 |
| Example 1 | | | | |
| Comparative | 10 | 3 | 0.001 | 50 |
| Example 2 | | | | |

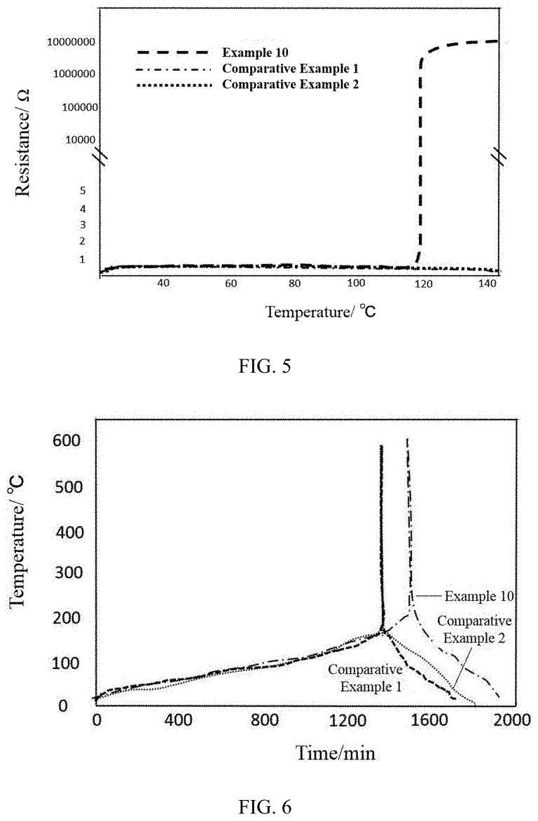

1. Electrode plate resistance test results: FIG. 5 shows curves of changes of resistance values of positive electrode plates of Example 10, Comparative Example 1, and Comparative Example 2 as the temperature increases. It may be learned from FIG. 5, by comparing the resistance test results of the positive electrode plate of Example 10 with those of Comparative Example 1 and Comparative Example 2, it was found that the electrode plate resistances of the positive electrode plates of Comparative Example 1 and Comparative Example 2 decreased slightly throughout the temperature range of 20° C. to 140° C. The resistance of the positive electrode plate of Example 10 varied little at 20° C. to 115° C. At 115° C. to 125° C., as the thermosensitive polymer microspheres in the positive electrode plate melted to form a plurality of continuous electron blocking layers, the coating layer formed a current blockage, and the resistance increases exponentially, which may block the passage of ions and electrons and improve the safety performance of the battery.

2. An EIS test and a battery cycling performance test were performed on the batteries prepared in the examples and the comparative examples, and test results are shown in Table 4.

3. The batteries prepared in the examples and the comparative examples were tested by using the adiabatic accelerating rate calorimeter of PhiTEC I (ARC) model from the British HEL brand. The temperature was increased at a rate of 0.14° C./min inside the instrument, and the temperature of the battery was tested. The resulting thermal runaway temperature (the temperature at which the battery burns) is shown in Table 4. Example 10 and Comparative Examples 1 and 2 are representative, and the obtained test curves are shown in FIG. 6.

TABLE 4

| | | | Number of |
|---|---|---|---|
| | Thermal | Battery | cycles for |
| | runaway | internal | capacity |
| | temperature | resistance | retention |
| Number | (° C.) | (mΩ) | of 80% |
| Example 1 | 174 | 56.75 | 1290 |
| Example 2 | 179 | 30.34 | 2000 |
| Example 3 | 180 | 32.25 | 2330 |
| Example 4 | 183 | 18.21 | 3650 |
| Example 5 | 185 | 26.71 | 2940 |
| Example 6 | 177 | 59.23 | 1110 |
| Example 7 | 175 | 49.33 | 1525 |
| Example 8 | 179 | 54.24 | 1310 |
| Example 9 | 184 | 60.37 | 1070 |
| Example 10 | 187 | 55.35 | 1320 |
| Example 11 | 185 | 58.92 | 1060 |
| Example 12 | 174 | 54.42 | 1370 |
| Example 13 | 183 | 52.53 | 1474 |
| Example 14 | 169 | 63.62 | 1071 |
| Example 15 | 176 | 61.26 | 1142 |
| Example 16 | 189 | 57.33 | 1282 |
| Example 17 | 188 | 56.43 | 1278 |
| Example 18 | 179 | 57.66 | 1181 |
| Comparative | 149 | 52.71 | 1120 |
| Example 1 | | | |
| Comparative | 152 | 56.14 | 1263 |
| Example 2 | | | |

4. A cross-section of the thermosensitive coating layer region in the positive electrode plate prepared in Example 13 was observed by using a Hitachi's new thermal field emission scanning electron microscope SU5000, and the observation results are shown in FIG. 8. It may be learned from FIG. 8 that the thermosensitive polymer microspheres are evenly distributed in the thermosensitive coating layer, and other components (such as the conductive agent) are evenly mixed with the thermosensitive polymer microspheres and are in contact with each other to achieve functions such as electrical conductivity. It may also be learned that the thermosensitive microspheres in the thermosensitive coating layer account for about 70% of the total volume of the thermosensitive coating layer.

By comparing the EIS test results of the batteries prepared in the examples and the comparative examples, it is found that:

(1) Thermal Runaway

The thermal runaway temperatures of the examples were generally significantly higher than those of the comparative examples. The battery assembled with the positive electrode plate of the present disclosure has better safety.

The main cause obtained through analysis may be as follows: During the heating of a conventional battery from 100° C. to 180° C., there are SEI film cracks, and the positive electrode reacts violently with the electrolyte. Especially in the interval of 160° C. to 185° C., violent thermal runaway, fire, and other phenomena may occur. However, during the heating of the battery of the examples from 110° C. to 185° C., when the thermosensitive temperature is reached, a blocking layer is formed inside the battery to block an internal circuit of the battery, prolong a battery safety time, and increase a thermal runaway temperature of the battery.

(2) Under the premise of ensuring excellent safety performance, the battery prepared in the examples can also reach a better level of internal resistance and cycling performance, which can meet the requirements of conventional projects. An overall trend is that as the thickness of the positive electrode layer in the positive electrode plate increases, the internal resistance of the battery increases accordingly, and those skilled in the art can adjust the thickness of the positive electrode layer as required to obtain the required internal resistance and cycling performance.

(3) Experimental results of Example 10, Example 12, Comparative Example 1, and Comparative Example 2:

Battery internal resistance: Comparative Example 1 (52.71 mΩ)<Example 12 (54.42 mΩ)<Example 10 (55.35 mΩ)<Comparative Example 2 (56.14 mΩ). The positive electrode active materials in Example 10, Example 12, Comparative Example 1, and Comparative Example 2 have the same thickness, except whether the thermosensitive coating layer is present and the thickness of the coating layer. The main cause is that there is no positive electrode primer coating layer in Comparative Example 1, resulting in a slightly smaller internal resistance of the battery and less impact on battery performance.

Number of cycles of the battery: 1320 cycles for the battery in Example 10 (capacity retention 80%), 1370 cycles for the battery in Example 12 (capacity retention 80%), 1120 cycles for the battery in Comparative Example 1 (capacity retention 80%), and 1250 cycles for the battery in Comparative Example 2 (capacity retention 80%). The main cause is that there is no positive electrode primer coating layer in Comparative Example 1. Although the internal resistance of the battery is slightly smaller in the early stage, with the cycling of the battery, factors such as battery polarization, dynamic internal resistance increase, and uneven positive electrode affect the battery cycling.

By comparing the cycling performance test results of the batteries prepared in the examples and the comparative examples, it is found that the functional safety coating layer in the positive electrode plate of the present disclosure can inhibit battery polarization, improve the consistency of the positive electrode, and improve the cycle life of the battery.

The experimental results show that a secondary battery assembled with the positive electrode plate of the present disclosure has better safety than a conventional secondary battery.

The implementations of the present disclosure are described above. However, the present disclosure is not limited to the foregoing implementations. Any modifications, equivalent replacements, improvements, and the like within the spirit and principle of the present disclosure shall fall within the scope of protection of the present disclosure.

What is claimed is:

1. A positive electrode plate, comprising a positive electrode current collector, a thermosensitive coating layer, a composite fusion layer, and a positive electrode active material layer, wherein at least one set of the thermosensitive coating layer and the positive electrode active material layer is provided on a surface of the positive electrode current collector, and the composite fusion layer is provided between the thermosensitive coating layer and the positive electrode active material layer;
the thermosensitive coating layer comprises thermosensitive polymer microspheres, a first conductive agent, a first binder, an auxiliary agent, and an optional first positive electrode active material;
the positive electrode active material layer comprises a second positive electrode active material, a second conductive agent, and a second binder; and
the composite fusion layer comprises the thermosensitive polymer microspheres, the first conductive agent, the first binder, the auxiliary agent, the second positive electrode active material, the second conductive agent, the second binder, and the optional first positive electrode active material.

2. The positive electrode plate according to claim 1, wherein one set of the thermosensitive coating layer and the positive electrode active material layer is provided on the surface of the positive electrode current collector, and the thermosensitive coating layer and the positive electrode active material layer are provided on the surface of the positive electrode current collector in one of the following sequences:
(1) the positive electrode current collector, the thermosensitive coating layer, and the positive electrode active material layer;
(2) the positive electrode current collector, the thermosensitive coating layer, the positive electrode active material layer, and the thermosensitive coating layer;
(3) the positive electrode current collector, the positive electrode active material layer, and the thermosensitive coating layer; and
(4) the positive electrode current collector, the positive electrode active material layer, the thermosensitive coating layer, and the positive electrode active material layer.

3. The positive electrode plate according to claim 1, wherein N thermosensitive coating layers and M positive electrode active material layers are successively and alternately provided on the surface of the positive electrode current collector, and P composite fusion layers are provided, and wherein N≥2, N+1≥M≥N−1, M≥2, and P=N+M−1.

4. The positive electrode plate according to claim 3, wherein N=2, 3, or 4.

5. The positive electrode plate according to claim 3, wherein the thermosensitive coating layer and the positive electrode active material layer are provided on the surface of the positive electrode current collector in one of the following sequences:
(1) the positive electrode current collector, the thermosensitive coating layer, the positive electrode active material layer, . . . , the thermosensitive coating layer, and the positive electrode active material layer;
(2) the positive electrode current collector, the thermosensitive coating layer, the positive electrode active material layer, . . . , the thermosensitive coating layer, the positive electrode active material layer, and the thermosensitive coating layer;
(3) the positive electrode current collector, the positive electrode active material layer, the thermosensitive coating layer, . . . , the positive electrode active material layer, the thermosensitive coating layer, and the positive electrode active material layer; and
(4) the positive electrode current collector, the positive electrode active material layer, the thermosensitive coating layer, . . . , the positive electrode active material layer, and the thermosensitive coating layer.

6. The positive electrode plate according to claim 1, wherein each thermosensitive coating layer independently comprises components of the following weight percentages:
1.1˜95 wt % of the thermosensitive polymer microspheres, 2.9˜48.9 wt % of the first conductive agent, 2˜40 wt % of the first binder, and 0.1˜10 wt % of the auxiliary agent; or
5˜90 wt % of the thermosensitive polymer microspheres, 5˜90 wt % of the first positive electrode active material, 2.9˜40 wt % of the first conductive agent, 2˜20 wt % of the first binder, and 0.1˜5 wt % of the auxiliary agent.

7. The positive electrode plate according to claim 6, wherein each thermosensitive coating layer independently comprises components of the following weight percentages:
65˜80 wt % of the thermosensitive polymer microspheres, 5˜15 wt % of the first positive electrode active material, 5˜15 wt % of the first conductive agent, 4.5˜15 wt % of the first binder, and 0.1˜4 wt % of the auxiliary agent.

8. The positive electrode plate according to claim 1, wherein each positive electrode active material layer independently comprises components of the following weight percentages:
80˜99 wt % of the second positive electrode active material, 0.5˜10 wt % of the second conductive agent, and 0.5˜10 wt % of the second binder.

9. The positive electrode plate according to claim 1, wherein a thickness of the thermosensitive coating layer ranges from 0.1 μm to 5 μm.

10. The positive electrode plate according to claim 1, wherein a thickness of the current collector ranges from 0.1 μm to 20 μm; and/or
a thickness of the composite fusion layer ranges from 0.001 μm to 0.5 μm; and/or
a thickness of the positive electrode active material layer ranges from 5 μm to 175 μm; and/or
a thickness of the positive electrode plate ranges from 50 μm to 200 μm.

11. The positive electrode plate according to claim 1, wherein a particle size of the thermosensitive polymer microspheres ranges from 100 nm to 3 μm.

12. The positive electrode plate according to claim 1, wherein a thermosensitive temperature of the thermosensitive polymer microspheres ranges from 115° C. to 160° C.

13. The positive electrode plate according to claim 1, wherein the thermosensitive polymer microspheres are selected from at least one of polyethylene, polypropylene, polyamide, polyester amide, polystyrene, polyvinyl chloride, polyester, polyurethane, olefin copolymer, or a monomer-modified copolymerized polymer thereof.

14. The positive electrode plate according to claim 13, wherein the thermosensitive polymer microspheres are selected from at least one of polyethylene, polypropylene, a propylene-ethylene-acrylate copolymer with a mole ratio between propylene and ethylene/acrylate being (10-1):1, an ethylene-acrylate copolymer with a mole ratio between ethylene and propylene being (10-1):1, an ethylene-acrylate copolymer with a mole ratio between ethylene and acrylate being (10-1):1, and an ethylene-vinyl acetate copolymer with a mole ratio between ethylene and vinyl acetate being (10-1):1.

15. The positive electrode plate according to claim 1, wherein a resistance of the positive electrode plate is less than 10Ω.

16. The positive electrode plate according to claim 1, wherein in the thermosensitive coating layer, a sum of volumes of the thermosensitive polymer microspheres accounts for 1.1% to 95% of a total volume of the thermosensitive coating layer.

17. A method for preparing the positive electrode plate according to claim 1, the method comprising the following steps:
(1) performing first mixing on a first solvent, thermosensitive polymer microspheres, a first conductive agent, a first binder, an auxiliary agent, and an optional first positive electrode active material, to obtain thermosensitive coating layer slurry;
(2) performing second mixing on a second solvent, a second positive electrode active material, a second conductive agent, and a second binder, to obtain positive electrode active material layer slurry; and
(3) successively and alternately applying the thermosensitive coating layer slurry obtained in step (1) or the positive electrode active material layer slurry obtained in step (2) on a surface of a positive electrode current collector, and drying to obtain the positive electrode plate.

18. A battery, comprising the positive electrode plate according to claim 1.

19. The battery according to claim 18, wherein the battery is a secondary battery and/or a lithium-ion battery.

20. The battery according to claim 18, wherein when a capacity retention of the battery decreases to 80% at 25° C. and a 1C/1C charge-discharge regime, a number of cycles is greater than or equal to 1100.
